(19) United States
(12) Patent Application Publication
(10) Pub. No.: US 2009/0003235 A1
(43) Pub. Date: Jan. 1, 2009

(54) Method and Apparatus For Data Frame Transmission

(75) Inventor: Zhangzhen Jiang, Guangdong (CN)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: HUAWEI TECHNOLOGIES CO., LTD.

(21) Appl. No.: 11/792,943

(22) PCT Filed: Jun. 15, 2006
(86) PCT No.: PCT/CN2006/001345

§ 371 Date: Oct. 23, 2007

(30) Foreign Application Priority Data
Jul. 27, 2005 (CN) 200510087196.3

(51) Int. Cl. H04L 12/26

(52) U.S. Cl. 370/253

(57) ABSTRACT

A method for data frame transmission includes: obtaining a Maximum Transmission Unit (MTU) of a sink; determining whether an MTU of a source is larger than the MTU of the sink, if the MTU of the source is larger than the MTU of the sink, taking the MTU of the sink as a threshold to send a data frame; otherwise, taking the MTU of the source as the threshold to send the data frame. The method and apparatus provided by embodiments of the present invention prevent loss of frame at the sink caused by the difference between the MTUs of the transmitting device and the receiving device in data transmission.

### FIELD OF THE INVENTION

The present invention relates to data frame transmission technology in communication systems, and particularly, to a method and an apparatus for data frame transmission by confining the size of a data frame to a Maximum Transmission Unit (MTU).

### BACKGROUND OF THE INVENTION

In order to fully utilize existing Synchronous Optical Network (SONET)/Synchronous Digital Hierarchy (SDH) and Optical Transmission Network (OTN), telecommunication operators usually map data of various upper layer services (e.g., Ethernet, Internet Protocol/Point-to-Point Protocol (IP/PPP), Multi-Protocol Label Switching (MPLS), etc.) to the SONET/SDH and OTN for transmission through a Generic Framing Procedure (GFP).

The GFP is put forward by the Telecommunication Standardization Sector of International Telecommunications Union (ITU-T), and the detailed description of the GFP is given in the ITU-T G7041/Y.1303. The transmission scheme of the GFP is explained hereinafter.

FIG. 1 shows the structure of a GFP protocol stack. As shown in FIG. 1, the data frame defined by the GFP is able to carry Ethernet Data 11, IP/PPP Data 12 and upper layer client service data 13 employing other protocols. The GFP frame also includes a field relevant to the upper layer client service data, e.g., payload header 14, and includes a general information field 15, e.g., core header, which is not related to the upper layer client service data; transmission paths available for the GFP frame include: SDH Virtual Container Path (SDH VC-n Path) 16, OTN Optical channel Data Unit Path (OTN ODUk Path) 17, and other octet-synchronous paths 18.

FIG. 2 shows a process of data packet transmission in a communication system employing GFP. As shown in FIG. 2, in a data communication device, each synchronous path has a corresponding buffer 21. The upper layer service data packet to be transmitted, e.g., an Ethernet data packet or a PPP data packet, is encapsulated into a GFP frame by a GFP module (FIG. 2 is a simplified schematic diagram, and the GFP module is not shown) at the source (e.g., communication device A), and retrieved from the GFP frame by a de-capsulation process at a sink (e.g., communication device B) to obtain the original upper layer service data packet. When the communication device A sends the GFP frame through the synchronous path, the GFP frame is put into the buffer 21 of the synchronous path first, then the GFP frame is read from the buffer 21 sequentially and send through the synchronous path. Similarly, when the communication device B receives the GFP frame through the synchronous path, the GFP frame is put into the buffer 21 of the synchronous path first, then retrieved from the buffer 21 by an upper layer application module and de-capsulated. Therefore, the size of the GFP frame is limited by the size of the buffer 21, and the buffer 21 must have a capacity of at least one GFP frame. Generally, a Maximum Transmission Unit (MTU) of the transmission path is set according to the size of the buffer 21, the MTU is used for identifying the maximum length of the payload of the GFP frame that can be sent or received by the communication device, i.e., the GFP frame can be put into the buffer 21 only when the payload length of the GFP frame is smaller than or equal to the MTU.

However, for the same transmission path, if the MTU of the source is larger than that of the sink, the payload length of the GFP frame sent from the source may very possibly be larger than the MTU of the sink, which makes it impossible for the buffer of the sink to hold the GFP frame, so that the GFP frame will be discarded and the data is lost. If the MTU of the source is much larger than that of the sink, there is a very high possibility that the payload length of the GFP frame from the source is larger than the MTU of the sink, which will cause very serious loss of frame at the sink.

### SUMMARY OF THE INVENTION

Embodiments of the present invention provide a method for data frame transmission, which prevents loss of frame during data transmission caused by a Maximum Transmission Unit (MTU) difference between a transmitting device and a receiving device.

Embodiments of the present invention also provide an apparatus for data frame transmission, which prevents loss of frame during data transmission caused by a MTU difference between a transmitting device and a receiving device.

According to one embodiment of the present invention, the method for data frame transmission includes:

obtaining a Maximum Transmission Unit (MTU) of a sink;

determining whether an MTU of a source is larger than the MTU of the sink, if the MTU of the source is larger than the MTU of the sink, taking the MTU of the sink as a threshold to send a data frame; otherwise, taking the MTU of the source as the threshold to send the data frame.

An apparatus for data frame transmission includes:

an MTU processing unit, configured to obtain an MTU of the sink, determine whether the MTU of the source is larger than the MTU of the sink, if the MTU of the source is larger than the MTU of the sink, determine the MTU of the sink being a threshold;

a data frame encapsulation unit, configured to encapsulate an upper layer data packet into a data frame;

a buffer, configured to buffer the data frame encapsulated by the data frame encapsulation unit;

a transmission path, configured to read the data frame from the buffer and send the data frame.

In the method and apparatus provided by the embodiments of the present invention, the source obtains the MTU of the sink, when the MTU of the sink is smaller than that of the source, the source takes the MTU of the sink as the threshold for data frame transmission to ensure that the payload length of the data frame sent to the sink does not exceed the MTU of the sink, and therefore the frame loss at the sink caused by the difference between the MTUs of the source and sink is prevented.

Moreover, an upper layer of the source in the embodiments of the present invention may limit the length of the upper layer service data packet according to the MTU threshold so that the payload length of the encapsulated data frame will not exceed the MTU threshold, thus the embodiment of the present invention further solves the problem of packet loss at the source.

### BRIEF DESCRIPTION OF THE DRAWINGS

FIG. 1 is a schematic diagram illustrating the structure of a GFP protocol stack according to the related art.

FIG. 2 is a schematic diagram illustrating a process of data packet transmission in a communication system employing GFP.

FIG. 3 is a flow chart illustrating a process of data frame transmission according to an embodiment of the present invention.

FIG. 4 is a schematic diagram illustrating a first method to obtain the MTU of the sink according to an embodiment of the present invention.

FIG. 5 is a schematic diagram illustrating a second method to obtain the MTU of the sink according to an embodiment of the present invention.

FIG. 6 is a schematic diagram illustrating a third method to obtain the MTU of the sink according to an embodiment of the present invention.

FIG. 7 is a schematic diagram illustrating an apparatus for data frame transmission according to an embodiment of the present invention.

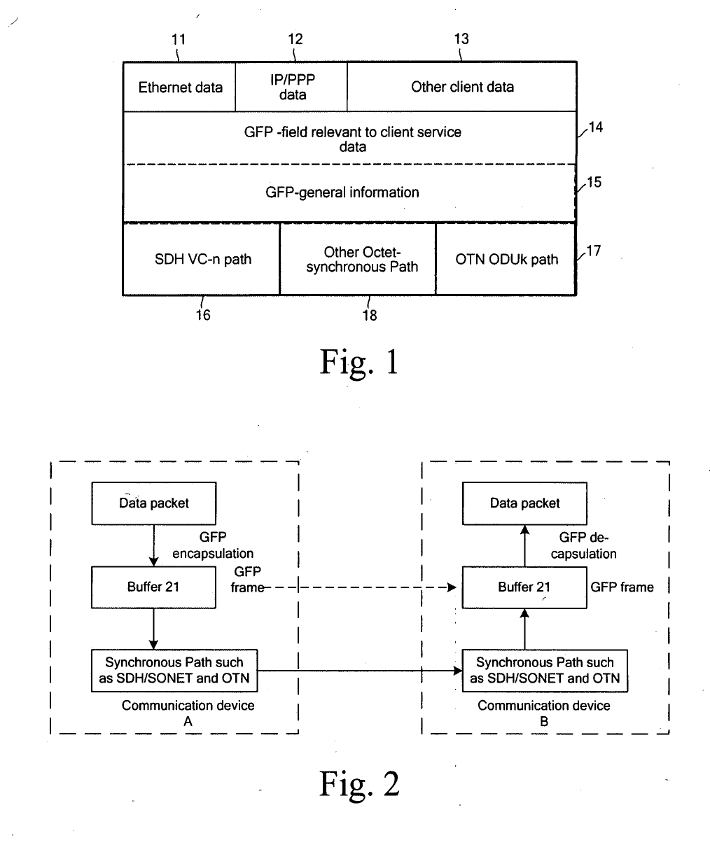

### EMBODIMENTS OF THE INVENTION

The present invention will be described in detail hereinafter with reference to accompanying drawings and embodiments.

The method provided by the embodiments of the present invention is applicable to communication systems similar to FIG. 2, which employ a buffer to transmit data frames. A description of an embodiment of the present invention is provided hereinafter, taking a communication system employing GFP as an example.

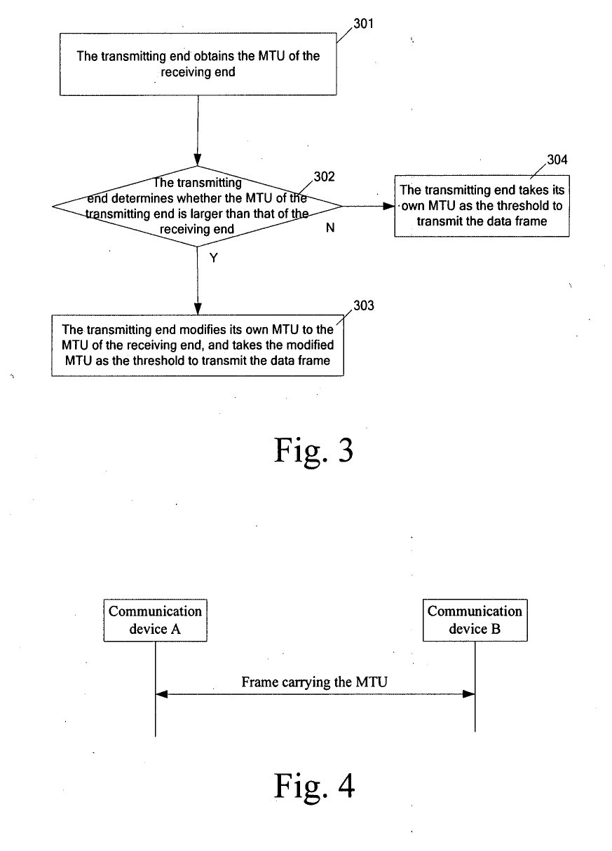

FIG. 3 is a flowchart of a process of data frame transmission according to an embodiment of the present invention. As shown in FIG. 3, the process includes:

Step 301: when a connection is established or after the connection is established, a source obtains the MTU of a sink. The MTU in the embodiment of the present invention refers to the maximum length of a data frame that can be received by a synchronous path of a communication device, and the MTU may be determined according to the size of the buffer of the synchronous path following existing method. Specifically to the GFP, the MTU is the maximum length of the payload of the GFP frame sent or received by the communication device.

Step 302: the source determines whether the MTU of the source is larger than the MTU of the sink, if the MTU of the source is larger than the MTU of the sink, proceed to Step 303; otherwise, proceed to Step 304.

Step 303: the source modifies the MTU of the source to the MTU of the sink and takes the modified MTU as a threshold to send the data frame. In the case of a GFP frame, the source determines whether the length of the payload encapsulated in the GFP frame is larger than the MTU of the sink, if the length of the payload encapsulated in the GFP frame is larger than the MTU of the sink, stops transmitting the GFP frame and sends an indication to the upper layer of the source (e.g., the Ethernet layer or PPP layer) indicating the length is overlarge. Upon the receipt of the indication, the upper layer of the source acquires the modified MTU and limits the length of the client service data packet according to the modified MTU to make sure that the length of the payload encapsulated in the GFP frame is within the threshold. The step of limiting the length of the client service data packet may be implemented through the existing fragment/concatenation method. If the length of the payload encapsulated in the GFP frame is smaller than or equal to the MTU of the sink, buffer and transmit the GFP frame, then the procedure ends.

After the source modifies the MTU of the source to that of the sink, the source may also send directly the modified MTU to the upper layer. The upper layer limits the length of the client service data packet according to the modified MTU to make sure that the length of the payload encapsulated in the GFP frame is within the modified MTU. Therefore the upper layer may control the length of the client service data packet and reduce the risk of packet loss at the source.

Step 304: the source sends the data frame taking the MTU of the source as the threshold, i.e., the source determines whether the length of the payload encapsulated in GFP frame is larger than the MTU of the source, if the length of the payload encapsulated in GFP frame is larger than the MTU of the source, stops transmitting the GFP frame, and sends an indication to the upper layer of the source indicating that the length is overlarge. Upon the receipt of the indication, the upper layer of the source limits the length of the client service data packet according to the MTU of the source to make sure that the length of the payload encapsulated in the GFP frame is within the MTU of the source; otherwise, buffer and transmit the GFP frame, and end the procedure.

In Step 301, there are several methods for the source to obtain the MTU of the sink; three of them are explained hereinafter.

FIG. 4 is a schematic diagram illustrating a first method to obtain the MTU according to an embodiment of the present invention. As shown in FIG. 4, in the first method, when the connection is established or after the connection is established, the source and the sink (e.g., the communication device A and the communication device B in FIG. 4) send, initiatively and respectively, a frame carrying their respective MTU to each other. The MTU may be carried by a GFP control frame. The value of the Payload. Length Indicator (PLI) of the header of the GFP control frame may be set to A, indicating that the GFP control frame carries an MTU. Where A may be 1, 2, or 3, and is saved in the communication device in advance. The MTU may be encapsulated in a designated field in the payload of the GFP control frame, and the location information of the designated field is also saved in the communication device in advance. Upon the receipt of the GFP frame, the peer side analyzes the header of the GFP frame, and if the value of the PLI of the header of the GFP frame is A, determines that the GFP frame is a GFP control frame carrying MTU, and extracts the MTU from the designated field in the payload of the GFP control frame to obtain the MTU. The MTU may also be carried by a GFP client management frame. The value of the User Payload Indicator (UPI) of the GFP client management frame may be set to B, indicating that the GFP client management frame carries an MTU; where B may be any value within the range of the UPI except 1 and 2, and is saved in the communication device in advance. The MTU is encapsulated in the header extension of the GFP client management frame, and a new field may be designated to carry the MTU to avoid confliction with other existing fields. Upon the receipt of the GFP client management frame, the peer side analyzes the value of the UPI, and if the value of the UPI is B, the peer side determines that the GFP client management frame carries an MTU and then analyzes the header extension of the GFP client management frame to obtain the MTU.

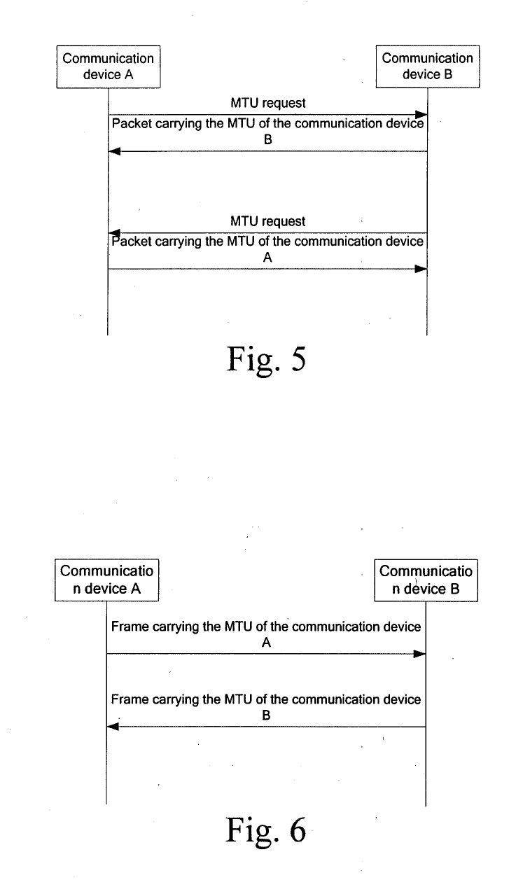

FIG. 5 is a schematic diagram illustrating a second method to obtain the MTU according to an embodiment of the present invention. As shown in FIG. 5, when the connection is established or after the connection is established, the source and the sink, e.g., the communication device A and the communication device B, respectively sends an MTU request to each other. Upon the receipt of the MTU request, the source and the sink respectively carries its own MTU in a packet and sends the packet in response to the MTU request. Upon the receipt of the packet and after successfully extracting the MTU from the packet, the source and the sink respectively send a response packet to each other. If the source or the sink fails to receive the packet or extract the MTU from the packet, the source or the sink sends an MTU request again after a period of time. The MTU request and the response packet may be specific GFP control frames, and may be identified by the PLI of the header of the GFP control frame. The packet carrying the MTU may be a GFP control frame or a GFP client management frame. The implementation is the same as that in the first method.

FIG. 6 is a schematic diagram illustrating a third method to obtain the MTU according to an embodiment of the present invention. As shown in FIG. 6, when the connection is established or after the connection is established, one of the source and the sink, e.g., the communication device A, carries its own MTU in a packet and sends the packet to the communication device B. Upon the receipt the packet, the communication device B carries its own MTU in another packet and sends the packet in response to the packet from the communication device A. The packet carrying the MTU may be a GFP control frame or a GFP client management frame. The implementation is the same as that in the first method.

In addition, in Step 301, the source may obtain the MTU of the sink regularly, or upon a trigger, e.g., when the synchronous path is launched again after being closed, the source may be triggered to obtain the MTU of the sink.

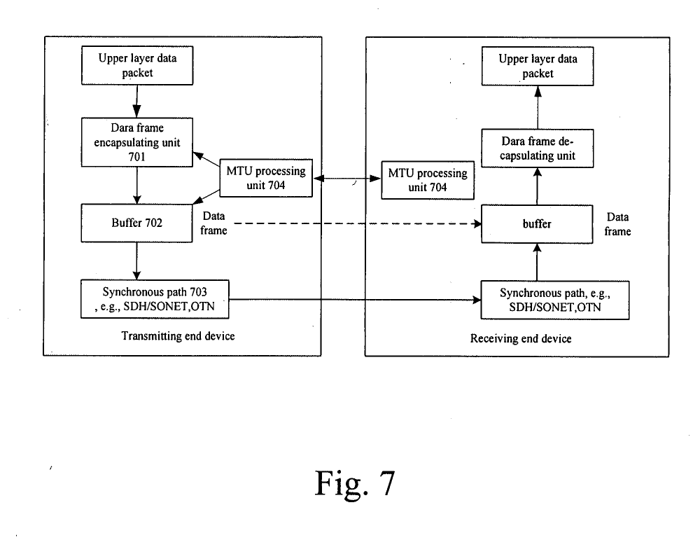

FIG. 7 is a schematic diagram illustrating the apparatus of the data frame transmission according to an embodiment of the present invention. As shown in FIG. 7, the apparatus of data frame transmission includes:

an MTU processing unit 704, configured to obtain the MTU of the sink, determine whether the MTU of the source is larger than the MTU of the sink, if the MTU of the source is larger than the MTU of the sink, determine the MTU of the sink to be a threshold;

a data frame encapsulation unit 701, configured to encapsulate an upper layer data packet into a data frame according to the threshold determined by the MTU processing unit 704; specifically in the embodiment of the present invention, the data frame encapsulation unit 701 may be a GFP module configured to encapsulate the upper layer data packet into a GFP frame;

a buffer 702, configured to buffer the data frame encapsulated by the data frame encapsulation unit 701;

a transmission path 703, configured to read the data frame from the buffer 702 and send the data frame; the transmission path 703 may be a synchronous transmission path such as SDH/SONET and OTN;

Preferably, when the MTU of the source is larger than that of the sink, the MTU processing unit 704 is further configured to inform, upon the receipt of the MTU of the sink, the data frame encapsulation unit 701 to encapsulate the data frame according to the MTU of the sink.

The MTU processing unit 704 is equipped on both the source and the sink. Since the communication is a bidirectional process, the source is also equipped with modules identical to those of the sink, and vice versa. FIG. 7 only shows a unidirectional communication for simplicity, those skilled in the art should understand that the communication devices on both sides include the modules provided by the embodiment of the present invention. When the connection is established or after the connection is established, the MTU processing unit 704 on both sides of the communication devices initiatively sends their respective MTU to each other. Or, the MTU processing unit 704 on both sides of the communication devices respectively sends an MTU request to each other requesting the MTU of the peer side; upon the receipt of the MTU request, the MTU processing unit of the peer side sends its own MTU in response to the MTU request; or, the MTU processing unit 704 on either side of the communication devices sends its own MTU to the MTU processing unit 704 of the peer side, and the peer side sends the MTU of the peer side in response.

The MTU may be carried by the GFP control frame. The MTU may be carried in a designated field of payload of the GFP control frame, and the PLI of the header of the GFP control frame may be 1, 2 or 3.

The MTU may also be carried by the GFP client management frame. The MTU is carried in the header extension of the GFP client management frame.

The foregoing is only preferred embodiments of this invention. The protection scope of this invention, however, is not limited to the above description. Any change or substitution, within the technical scope disclosed by this invention, easily occurring to those skilled in the art should be covered by the protection scope of this invention.

1. A method for data frame transmission, comprising:
obtaining a Maximum Transmission Unit (MTU) of a sink;
determining whether an MTU of a source is larger than the MTU of the sink, if the MTU of the source is larger than the MTU of the sink, taking the MTU of the sink as a threshold to send a data frame; otherwise, taking the MTU of the source as the threshold to send the data frame.

2. The method of claim 1, wherein the obtaining an MTU of a sink comprises:
sending, by the sink, the MTU of the sink to the source.

3. The method of claim 1, wherein the obtaining an MTU of a sink comprises:
sending, by the source, a request to the sink, requesting the MTU of the sink;
upon the receipt of the request, sending, by the sink, the MTU of the sink to the source.

4. The method of claim 1, wherein the obtaining an MTU of a sink comprises any one of:
sending, by the source, the MTU of the source to the sink; upon the receipt of the MTU, returning, by the sink, the MTU of the sink to the source in response to the MTU of the source; and
sending, by the sink, the MTU of the sink to the source; upon the receipt of the MTU, returning, by the source, the MTU of the source to the sink in response to the MTU of the sink.

5. The method of claim 2, wherein the MTU is carried in a designated field in payload of a Generic Framing Procedure (GFP) control frame; and the value of a Payload Length Indicator (PLI) of a header of the GFP control frame is 1, 2 or 3.

6. The method of claim 2, wherein the MTU is carried in header extension of a GFP client management frame.

7. The method of claim 1, further comprising:
if the MTU of the source is larger than the MTU of the sink, limiting, by upper layer of the source, the length of an upper layer service data packet to the MTU of the sink.

8. The method of claim 1, wherein the process of taking the MTU of the sink as a threshold to send a data frame comprises:
determining whether the length of payload encapsulated in the data frame is larger than the MTU of the sink, if the payload length encapsulated in the data frame is larger than the MTU of the sink, stopping transmitting the data frame, and sending an indication to the upper layer of the source indicating that the length is overlarge; otherwise, buffering and transmitting the data frame.

9. The method of claim 8, further comprising:
upon the receipt of the indication, limiting, by the upper layer of the source, the length of the upper layer service data packet according to the MTU of the sink.

10. An apparatus for data frame transmission, comprising:
a Maximum Transmission Unit (MTU) processing unit, configured to obtain a first MTU, determine whether a second MTU is larger than the first MTU, and if the second MTU is larger than the first MTU, determine the first MTU to be a threshold;
a data frame encapsulation unit, configured to encapsulate an upper layer data packet into a data frame according to the threshold determined by the MTU processing unit;
a buffer, configured to buffer the data frame encapsulated by the data frame encapsulation unit;
a transmission path, configured to read the data frame from the buffer and send the data frame.

11. The apparatus of claim 10, wherein the MTU processing unit is further configured to inform the data frame encapsulation unit to replace the second MTU by the first MTU to encapsulate the upper layer data packet when the second MTU is larger than the first MTU.

12. The apparatus of claim 10, wherein the MTU processing unit is further configured to send the second MTU, and receive the first MTU.

13. The apparatus of claim 10, wherein the MTU processing unit is further configured to send a first request requesting the first MTU, receive a second request and send the second MTU upon the receipt of the second request.

14. The apparatus of claim 10, wherein the MTU processing unit is further configured to receive a request requesting the second MTU, and return the second MTU.

15. The apparatus of claim 12, wherein the MTU is carried in a designated field in payload of a Generic Framing Procedure (GFP) control frame; and the value of a Payload Length Indicator (PLI) of header of the GFP control frame is 1, 2 or 3.

16. The apparatus of claim 12, wherein the MTU is carried by in header extension of a GFP client management frame.

17. The method of claim 3, wherein the MTU is carried in a designated field in payload of a Generic Framing Procedure (GFP) control frame; and the value of a Payload Length Indicator (PLI) of a header of the GFP control frame is 1, 2 or 3.

18. The method of claim 4, wherein the MTU is carried in a designated field in payload of a Generic Framing Procedure (GFP) control frame; and the value of a Payload Length Indicator (PLI) of a header of the GFP control frame is 1, 2 or 3.

19. The method of claim 3, wherein the MTU is carried in header extension of a GFP client management frame.

20. The method of claim 4, wherein the MTU is carried in header extension of a GFP client management frame.

21. The apparatus of claim 17, wherein the MTU is carried in a designated field in payload of a Generic Framing Procedure (GFP) control frame; and the value of a Payload Length Indicator (PLI) of header of the GFP control frame is 1, 2 or 3.

22. The apparatus of claim 18, wherein the MTU is carried in a designated field in payload of a Generic Framing Procedure (GFP) control frame; and the value of a Payload Length Indicator (PLI) of header of the GFP control frame is 1, 2 or 3.

23. The apparatus of claim 17, wherein the MTU is carried by in header extension of a GFP client management frame.

24. The apparatus of claim 18, wherein the MTU is carried by in header extension of a GFP client management frame.
